(19) United States
(12) Patent Application Publication
(10) Pub. No.: US 2006/0205301 A1
(43) Pub. Date: Sep. 14, 2006

(54) Composite membrane having hydrophilic properties and method of manufacture

(75) Inventors: Robert J. Klare, St. Joseph, MO (US); James DeYoung, Durham, NC (US); James B. McClain, Raleigh, NC (US); Douglas E. Betts, Durham, NC (US)

Correspondence Address: PATRICK W. RASCHE (22402), ARMSTRONG TEASDALE LLP, ONE METROPOLITAN SQUARE, SUITE 2600, ST. LOUIS, MO, 63102-2740, US

(73) Assignees: BHA Technologies, Inc.; Micell Technologies, Inc.

(21) Appl. No.: 11/077,760

(22) Filed: Mar. 11, 2005

(51) Int. Cl. B32B 5/02; B32B 27/04; B32B 3/00

(52) U.S. Cl. 442/63; 442/59; 442/118

(57) ABSTRACT

A composite article, in an exemplary embodiment, includes a porous base membrane made from a first material having hydrophobic properties, and a coating layer formed on at least a portion of the porous membrane. The coating layer includes a crosslinked coating material, and has hydrophilic properties.

### BACKGROUND OF THE INVENTION

This invention relates generally to composite porous membranes, and more particularly to, composite porous membranes having hydrophilic properties.

Fluoropolymers have excellent chemical and heat resistance and in general are hydrophobic. Expanded porous polytetrafluoroethylene (ePTFE) polymer membranes can be useful as filter media for liquid filtration. Because of the hydrophobicity of fluoropolymers, aqueous dispersions cannot readily be filtered through filters made from these fluoropolymers. Such ePTFE filters can be prewetted with organic solvents followed by flushing with water or using pressure to overcome the lack of affinity between the hydrophobic material and the polar aqueous dispersion. However, such prewetting is expensive over the long term and can lead to “gas-lock” or “dewetting.”

There have been various attempts to make fluoropolymer surfaces more hydrophilic and receptive to wetting with water while still maintaining their desirable properties. One approach is to coat the surface and the interior of the pores with a fluorinated surfactant to improve hydrophilicity. Since the fluoro-surfactant is bound to the surface of the membrane only by means of chemical affinity, the weakness of this approach is that over a period of time the fluoro-surfactant will be washed out by the aqueous medium and the fluoropolymer membrane will lose its water-wettability. Another approach has been to use a fluoro-surfactant which is then crosslinked by an irradiation treatment using a high energy radiation beam such as Gamma ray, electron beam or non-equilibrium plasma. Such a crosslinked fluoro-surfactant will not diffuse out of the fluoropolymer matrix even when it is exposed to aqueous flow for an extended period of time. However, the high energy radiation weakens the mechanical strength of the fluoropolymer and the fluorinated surfactant will also suffer adverse effects ranging from deterioration of properties to alteration of its chemical properties.

### BRIEF DESCRIPTION OF THE INVENTION

In one aspect, a composite article is provided. The composite article includes a porous base membrane made from a first material having hydrophobic properties, and a coating layer formed on at least a portion of the porous membrane. The coating layer includes a crosslinked coating material, and the crosslinked coating layer has hydrophilic properties.

In another aspect, a method of making a composite membrane having hydrophilic properties is provided. The method includes the steps of providing a porous membrane having a plurality of pores and made from a first material having hydrophobic properties, dissolving a coating material in a fluid comprising densified gas, exposing the porous membrane to the coating material dissolved in the densified gas, and depositing a uniform coating of the coating material onto surfaces defining the pores in the porous membrane by changing the conditions of the fluid to below a solubility limit of the coating material in the fluid. The method also includes crosslinking the coating material to form a coating layer, and chemically treating the coating material to impart hydrophilic properties to the coating layer, wherein the crosslinking step is performed before or after the chemically treating step.

In another aspect, a composite membrane is provided. The composite membrane includes a porous base membrane made from a first material having hydrophobic properties, and a coating layer formed on at least a portion of the porous membrane. The coating layer is formed from a crosslinked coating material. The coating material includes at least one of fluorinated vinyl-based copolymers having sulfonyl functionality, trifuoroacetate functionality, and/or acetate functionality, fluorinated acrylic-based copolymers having at least one of hydroxyl groups, acid groups, sulfonyl groups, and sulfonic acid groups, and fluorinated styrenic-based copolymers having at least one of hydroxyl groups, acid groups, sulfonyl groups, and sulfonic acid groups.

### BRIEF DESCRIPTION OF THE DRAWINGS

FIG. 1 is a plan schematic view of a composite membrane in accordance with an embodiment of the present invention.

FIG. 2 is an enlarged sectional schematic view of a portion of the membrane shown in FIG. 1.

FIG. 3 is a schematic illustration of the synthesis and coating of an polyvinyl trifluoroacetate coating onto the composite membrane shown in FIG. 1.

FIG. 4 is a schematic illustration of the synthesis and coating of an ionic PVDF-based coating onto the composite membrane shown in FIG. 1.

FIG. 5 is a scanning electron microscope picture of the membrane shown in FIG. 3 after a three wet and dry cycle test.

FIG. 6 is a schematic illustration of the coating equipment used to make the composite membrane shown in FIG. 1.

### DETAILED DESCRIPTION OF THE INVENTION

A composite membrane having hydrophilic properties and a method of making the composite membrane are discussed in detail below. The composite membrane includes, in an exemplary embodiment, a porous base membrane having a plurality of pores and a coating applied to the base membrane using a densified gas, for example, a supercritical fluid or a near critical fluid, as a solvent. The coating is deposited onto the base membrane without blocking the pores of the membrane by changing the conditions of the supercritical fluid, for example, temperature and/or pressure. The coating used is selected to be compatible with the material of the base membrane and impart hydrophilic properties to the membrane. By compatible is meant that the coating material will “wet-out” the surface of the base membrane. The coating is crosslinked to improve adhesion and to provide that the composite article remains hydrophilic after at least 3 wet then dry cycles with no more than 10 percent of coating washout. In another embodiment, the coating is not crosslinked. The composite membrane retains water etability and can be dried and subsequently flow water with no special pre-wetting procedures.

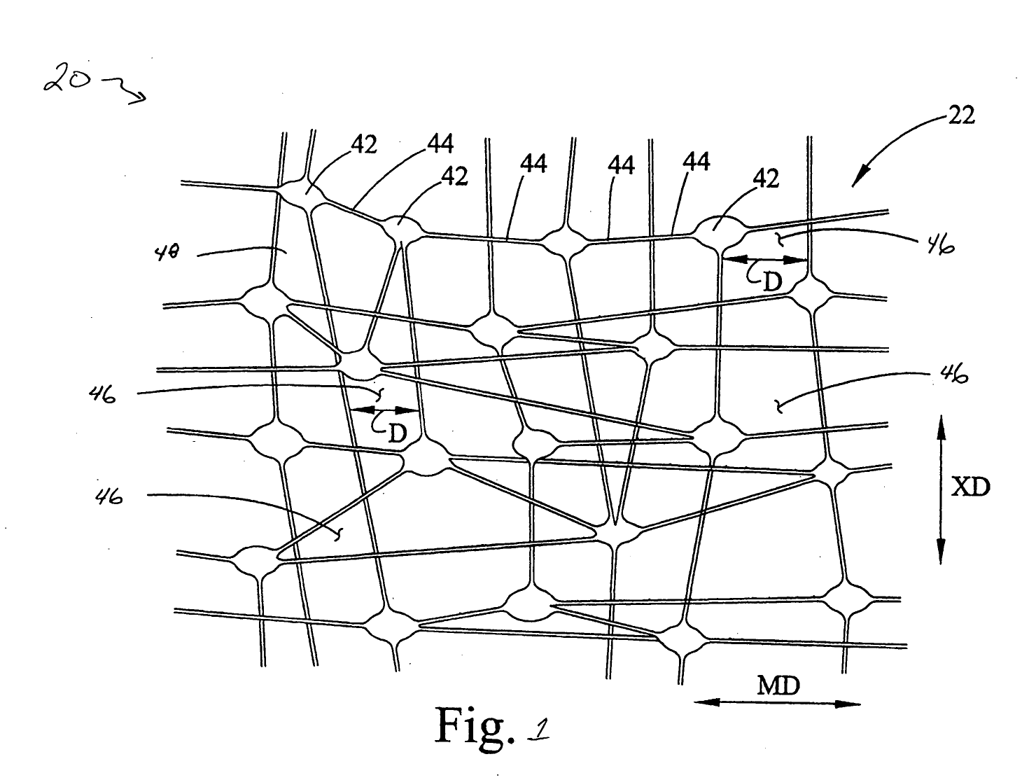

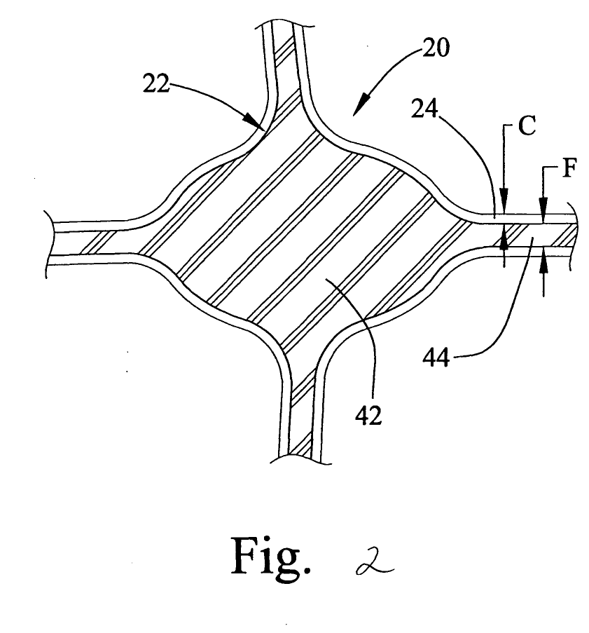

Referring to the drawings, FIG. 1 is a plan view of a composite membrane 20 in accordance with an embodiment of the present invention and FIG. 2 is an enlarged sectional view of a portion of membrane 20. In an exemplary embodiment, composite membrane 20 includes a porous base membrane 22. Base membrane 22 is made from any suitable material, for example, expanded polytetrafluoroethylene (ePTFE) or a PTFE fabric. A porous ePTFE membrane 22 has excellent hydrophobic properties, a low surface energy, and is chemically inert. A coating layer 24 is formed on porous base membrane 22 by any suitable coating that would change or modify at least one property or characteristic of base membrane 22, such as, without limitation, hydrophilicity, electrical conductivity, ion conductivity or compatibility with another material. By compatible it is meant that coating material will “wet-out” the surface of base membrane 22 to form a continuous, conformal coating layer 24.

There are numerous uses for a porous membrane having a property or characteristic that has been changed or modified. For example, composite membrane 20 can be used in applications, including but not limited to liquid filtration, polarity-based chemical separations, electrolysis, batteries, pervaporization, gas separation, dialysis separation, industrial electrochemistry such as chloralkali production and electrochemical applications, super acid catalysts, or use as a medium in enzyme immobilization.

In the exemplary embodiment, base membrane 22 is porous, and in one embodiment microporous, with a three-dimensional matrix or lattice type structure including plurality of nodes 42 interconnected by a plurality of fibrils 44. Surfaces of the nodes 42 and fibrils 44 define a plurality of pores 46 in membrane 22. Membrane 22 is made from any suitable material, and in the exemplary embodiment is made of expanded polytetrafluoroethylene (ePTFE) that has been at least partially sintered. Generally, the size of a fibril 44 that has been at least partially sintered is in the range of about 0.05 micron to about 0.5 micron in diameter taken in a direction normal to the longitudinal extent of the fibril. The specific surface area of porous base membrane 22 is in the range of about 9 square meters per gram of membrane material to about 110 square meters per gram of membrane material.

Surfaces of nodes 42 and fibrils 44 define numerous interconnecting pores 46 that extend completely through membrane 22 between opposite major side surfaces in a tortuous path. In the exemplary embodiment, the average effective pore size of pores 46 in base membrane 22 is sufficient to be deemed microporous, but any pore size may be used in alternate embodiments. A suitable average effective pore size D for pores 46 in base membrane 22 is in the range of about 0.01 micron to about 10 microns, and in another embodiment, in the range of about 0.1 micron to about 5.0 microns.

In the exemplary embodiment, base membrane 22 is made by extruding a mixture of polytetrafluoroethylene (PTFE) fine powder particles and lubricant. The extrudate is then calendered. The calendered extrudate is then “expanded” or stretched in at least one and preferably two directions, MD and XD, to form fibrils 44 connecting nodes 42 to define a three-dimensional matrix or lattice type of structure. “Expanded” is intended to mean sufficiently stretched beyond the elastic limit of the material to introduce permanent set or elongation to fibrils 44. Base membrane 22 is then heated or “sintered” to reduce and minimize residual stress in the membrane material by changing portions of the material from a substantially crystalline state to a substantially amorphous state. In an alternate embodiment, base membrane 22 is unsintered or partially sintered as is appropriate for the contemplated end use of the membrane.

Other materials and methods can be used to form base membrane 22 having an open pore structure. For example, other suitable materials that can be used to form base membrane 22 include, but are not limited to, polyolefin, polyamide, polyester, polysulfone, polyether, acrylic and methacrylic polymers, polystyrene, polyurethane, polypropylene, polyethylene, polyphenelene sulfone, cellulosic polymer and combinations thereof. Other suitable methods of making base membrane 22 include foaming, skiving or casting any of the suitable materials. In alternate embodiments, base membrane 22 is formed from woven or non-woven fibers of the above described materials, such as PTFE.

Base membrane 22 contains many interconnected pores 46 that fluidly communicate with environments adjacent to the opposite facing major sides of the membrane. Therefore, the propensity of the PTFE material of base membrane 22 to permit a liquid material, for example, an aqueous liquid material, to wet out and pass through pores 46, is a function of the surface energy of membrane 22, the surface tension of the liquid material, the relative contact angle between the PTFE material of base membrane 22 and the liquid material, the size or effective flow area of pores 46, and the compatibility of the PTFE material of base membrane 22 and the liquid material. Most liquid materials are incompatible with PTFE and, therefore, it is difficult to get a liquid material into and through the pores of an ePTFE membrane.

Composite membrane 20, thus, includes a treatment or coating 24 on surfaces of base membrane 22 that is compatible with PTFE and which provides a hydrophilic surface to permit liquid materials to wet out and pass through composite membrane 20. Coating 24 adheres to and conforms to the surfaces of nodes 42 and fibrils 44 that define the pores 46 in the membrane 22. Selecting coating with a predetermined surface energy can permit selective flow through composite membrane 20 of certain surface tension fluids.

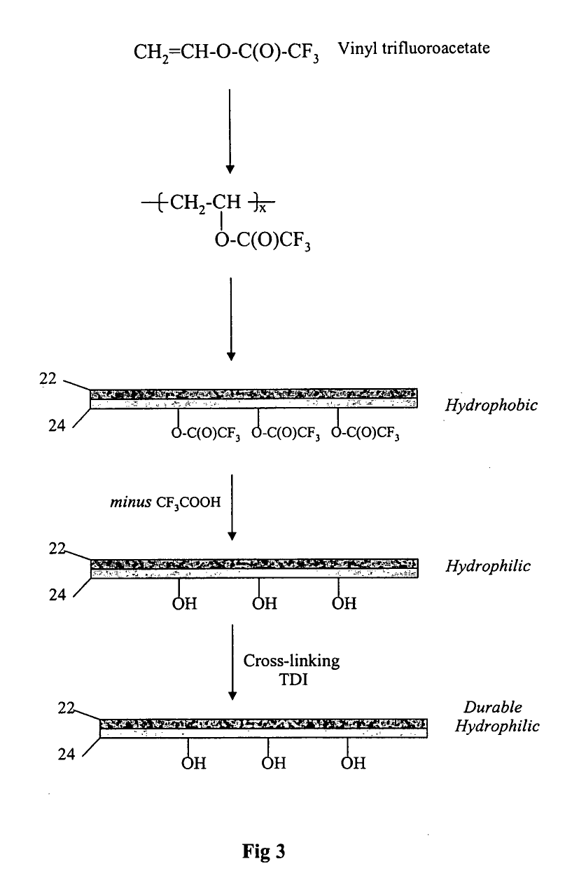

Coating 24 is a relatively thin and substantially uniform layer deposited onto base membrane 22. In the exemplary embodiment, coating 24 is a fluorinated vinyl-based copolymer having trifluoroacetate functionality, for example, polyvinyl trifluoroacetate (PVAc^{f}) or copolymers from vinyl trifluoroacetate and other vinylic, acrylic, or styrenic monomers. PVAc^{f} polymers are particularly useful for this application as these partially fluorinated polymers have increased CO₂ solubility and readily undergo solvolysis or hydrolysis to yield highly polar, wettable, and in some cases syndiotactic polyvinyl alcohol (PVOH). Upon facile conversion from PVAc^{f} to PVOH the polymer releases CF₃COOH as a byproduct. The loss of the fluoroalkyl group, normally credited for “anti-wetting” properties on surfaces, is ideal as it leaves the surface of the coated membrane highly polar and wettable. The synthesis of this material, subsequent coating onto a porous media, and conversion to a highly polar wettable polymer is represented in FIG. 3. The coating can be chemically cross-linked to enhance durability using methods known to those familiar with the art. For example, one such method is to treat coated and converted base membrane 22 with Toluene Di-Isocyanate (TDI) followed by heating.

In another exemplary embodiment, coating 24 is a vinylidene difluoride (VF₂) and sulfonyl fluoride functional perfluoroalkyl vinyl ether copolymer. Vinylidene difluoride co-polymers are used because of the potential incorporation of highly ionic functional (hydrogen bonding) groups, for example, by incorporation of a functional co-monomer, into the polymer coating in the form of a sulfonic acid pendant group. This highly polar functional group substantially enhances the hydrophilic wetting properties of typically highly hydrophobic fluorocarbon polymers. In one embodiment, the polymer is synthesized in the sulfonyl fluoride form, coated onto base membrane 22 and then converted to the sulfonic acid form on base membrane 22.

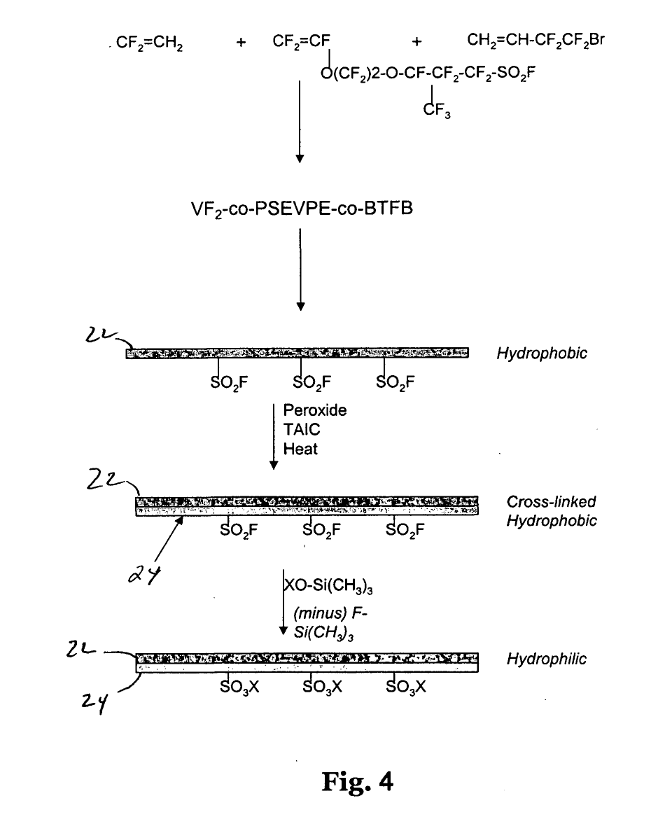

Fuorinated and semifluorinated olefin copolymers, for example, vinylidene difluoride, having sulfonyl fluoride functional perfluoroalkyl vinyl ether (PVDF-co-PSEVPE) with monomer ratios ranging from about 1:1 to about 5:1 are suitable for use as coating 24. Referring also to FIG. 4, the copolymer is entrained in a densified gas, deposited onto membrane 22 and the deposited coating is crosslinked. The deposited coating has hydrophobic properties and is treated to chemically convert the sulfonyl fluoride to sulfonic acid derivatives to convert the properties of the coating to hydrophilic. In one exemplary embodiment, a trimethyl silanoate sodium salt in polar solvents is used to chemically convert the sulfonyl fluoride. Once converted to the sulfonic acid derivative, the coating can be acidified to form the sulfonic acid functional coating. Both the sulfonic acid derivative and sulfonic acid functional coated membranes are wettable with neutral water and thus are hydrophilic making composite membrane 20 more compatible with fluids and permit flow through composite membrane 20.

Coating 24 is not limited to fluorocarbon vinyl-based polymers. Other exemplary coatings include vinylic-based, acrylic-based or styrenic-based polymers and copolymers. In this case, exemplary polymers are ideally partially fluorinated, having between 20% and 70% fluorine by weight, and have functional groups that can be reactively or thermally converted to form strong polar hydrogen-bonding functional groups such as hydroxyl (—OH) groups, acid groups (—COOH), sulfonyl groups (SO₂X) where X is a halogen, or sulfonic acid groups (SO₃H). Other exemplary, polymers include poly(vinyl acetate)-based polymers which can be thermally or chemically treated to form poly(vinyl alcohol) polymers once deposited on base membrane 22. In some embodiments the conversion process takes place immediately subsequent to the supercritical carbon dioxide (SCCO₂) deposition process, as part of that process, in other embodiments, the conversion takes place after the SCCO₂ deposition process is completed.

Substantially improved and modified properties of base membrane 22 are realized when the surfaces defining pores 46 in porous base membrane 22 and the major side surfaces of base membrane 22 are treated with any of the materials described above to form coating 24. The primary criteria for coating 24 as described above are two-fold. Coating 24 should have an affinity for the ePTFE membrane and simultaneously have functionality that provides hydrophilic properties to base membrane 22. This second functionality is generally characterized as providing strong hydrogen bonding potential such as is the case with the incorporation of hydroxyl, carboxylic acid, sulfonic acid, amide, imide, acetal, phosphoric acid, ammonium, or urethane functional groups. The limiting factor previously has been the lack of an effective way to introduce the treatment materials into pores 46 of membrane 22 to evenly coat the surfaces of nodes 42 and fibrils 44.

A fluid having a surface tension less than about 15 dynes/cm, for example, a densified gas, can be used to entrain or dissolve the above described materials and introduce the materials into pores 46 of porous base membrane 22. The densified gas can be in its liquid, supercritical, or near critical state, for example, supercritical carbon dioxide. In alternative embodiments, the densified gas can include a co-solvent. The solubility of coating material 24 in supercritical carbon dioxide is determined by experimentation. In the exemplary embodiment, coating material 24 is applied in a pre-converted state where the solubility of the polymer in dense CO₂ is not inhibited by the presence of significant quantities of hydrogen bonding groups. Once coated onto base membrane 22 as described herein, coating 24 is converted to the polar hydrogen bonding state. The pre-converted polymer is typically dissolved in liquid or supercritical CO₂ in concentrations ranging between about 1 and about 15 percent by weight at temperatures typically between about 0° C. and 300° C. and pressures between about 30 bar and about 850 bar. The resulting solution is capable of wetting membrane 22 and entering pores 46 in membrane 22 with the dissolved coating material 24. The solution with dissolved coating material 24 has a surface tension, viscosity and relative contact angle that permits the dissolved coating material 24 to be easily carried into pores 46 of base membrane 22. It should be noted that liquid molecules are attracted to one another at their surfaces, and liquids with relatively high levels of inter-molecular attraction possess high surface tension. The concept of “wetting” is a function of the surface energy of a liquid (′Y_{SL}), surface energy of a solid (′Y_{SA}) and the surface tension of a liquid ( [symbol] _{LA}), often described by the Young-Dupre equation below.
′Y_{SL}−′Y_{SA}= [symbol] _{LA}*COS(θ) (1)

Contact angle θ is a measure of the angle between the surface of a liquid drop and the surface of a solid taken at the tangent edge of where the liquid drop contacts the solid such that when the contact angle θ is 0°, a liquid will spread to a thin film over the solid surface. By comparison, a solid and liquid combination with a contact angle θ of 180° causes the liquid to form a spherical drop on the solid surface. When a contact angle θ between 0° and 90° exists, a liquid will “wet” the solid it is contacting and the liquid will be drawn into pores, if any, existing in the surface of a solid. When the contact angle θ is more than 90°, a liquid will not wet the solid and there will be a force needed to drive the liquid into any existing pores 46 present in base membrane 22.

In the exemplary embodiment, the solvent used for coating material 24 is carbon dioxide in a supercritical phase. The surface tension of the supercritical carbon dioxide (SCCO₂) solution is less than 0.1 dyne/cm so it can enter very small areas of base membrane 22 to coat. SCCO₂ and mixtures of SCCO₂ and coating materials also have a viscosity of less than about 0.5 centipoise. The viscosity and surface tension of the resultant solution are low compared to traditional solvents so resistance to flow is reduced, thus, lending itself to entering even the smallest pores 46 of base membrane 22. Thus, it is possible to enter and coat porous base membrane 22 material with a relatively small pore size. Most solvents have a viscosity greater than 0.5 cps and a surface tension greater than about 15 dynes/cm that make it difficult to enter small pores 46 in base membrane 22 formed from ePTFE and, therefore, it is difficult to coat all the surfaces of base membrane 22 with such liquids.

Attractive properties are provided by SCCO₂ because it behaves like a gas and a liquid at the same time. The density of SCCO₂ is variable and in one embodiment ranges between about 0.4 grams/cc and about 0.95 grams/cc in its supercritical phase, depending on the temperature and/or pressure, so it functions like a liquid solvent. When it behaves like a liquid, it can dissolve coating material 24 and act as a solvent as described above and still be pumped efficiently. When SCCO₂ behaves like a gas it has very low viscosity and surface tension, so it can enter very small spaces, such as relatively small pores 46 in base membrane 22 or spaces or voids in a node 42, fibril 44, or molecule forming base membrane 22.

Coating 24 is disposed on and around substantially all the surfaces of nodes 42 and fibrils 44 that define interconnecting pores 46 extending through untreated base membrane 22. In one exemplary embodiment, coating material 24 is deposited on the surfaces of nodes 42 and fibrils 44 by precipitation of coating material 24 from dense CO₂. In such a precipitation, particles of coating material 24 are generated and are attracted to base membrane 22. Precipitation can be affected by expansion (decrease in pressure) of the dense CO₂. As the fluid expands the fluid flows in 3-dimensions, and Brownian motion moves the coating particles into contact with nodes 42 and fibrils 44 surrounding pores 46. It is not necessary that coating 24 completely encapsulate the entire surface of a node 42 or fibril 44 to sufficiently modify the properties of base membrane 22. The relatively thin and uniformly even thickness C of coating 24 results from depositing numerous coating material particles on the majority of the surface area of base membrane 22, including surfaces of nodes 42 and fibrils 44. This deposition by precipitation occurs when the conditions, for example, pressure and/or temperature, of the dense CO₂ are changed to a level near to, or below the solubility limit of coating material 24. Such a process is described in U.S. Pat. No. 6,270,844 and U.S. patent application Ser. No. 10/255,043 which are assigned to at least one of the assignees of the present application and incorporated herein by reference.

Unlike a conventional solute precipitation process, the polymer coatings in the described method do not form ‘particle-like’ precipitates in the CO₂ fluid. As they precipitate from the low surface tension fluid the polymer stays highly swollen and the ePTFE material of base membrane remains completely wetted with the fluid and the CO₂-plasticsized polymer. As such, the fully precipitated polymer forms a conformal coating 24 around the 3-dimensional structure of base membrane 22 by coalescence. Process parameters are selected to control the thickness of coating 24 in the range of about 1.0 nanometer to about 500 nanometers and preferably in the range of about 1.0 nanometer to about 100 nanometers. In one embodiment, the ratio of the precipitated and deposited thickness C of coating 24 to a thickness F of fibril 22 is in the range of about 0.2% to about 40% and in another embodiment, about 0.2% to about 20%. The ratio of the precipitated and deposited thickness C of coating 24 to the effective average size D of the pores 46, in one embodiment, is in the range of about 0.2% to about 20% and in another embodiment, about 0.2% to about 10%.

The deposited coating material 24 adheres to surfaces of nodes 42 and fibrils 44 that define the pores 46 in base membrane 22. The deposited treatment material may be further processed if needed, such as by heating or by chemical conversion such as acid catalyzed de-protection, or acid, base, or thermally induced hydrolysis or saponification, or other suitable process. Coating material 24 provides a relatively thin and uniformly even property modifier to base membrane 22 that does not completely block or “blind” pores 46. In one embodiment, the composite membrane 20 has an air-permeability of at least about 0.10 CFM per square foot of membrane and in another embodiment, at least about 0.20 CFM per square foot of membrane measured by ASTM D737 testing.

Coating 24 provides increased strength to resist compression in the Z direction of the composite membrane 20, add tensile strength in the machine MD and transverse XD directions, has long lasting, or “durable”, hydrophilic properties for liquid filtration applications.

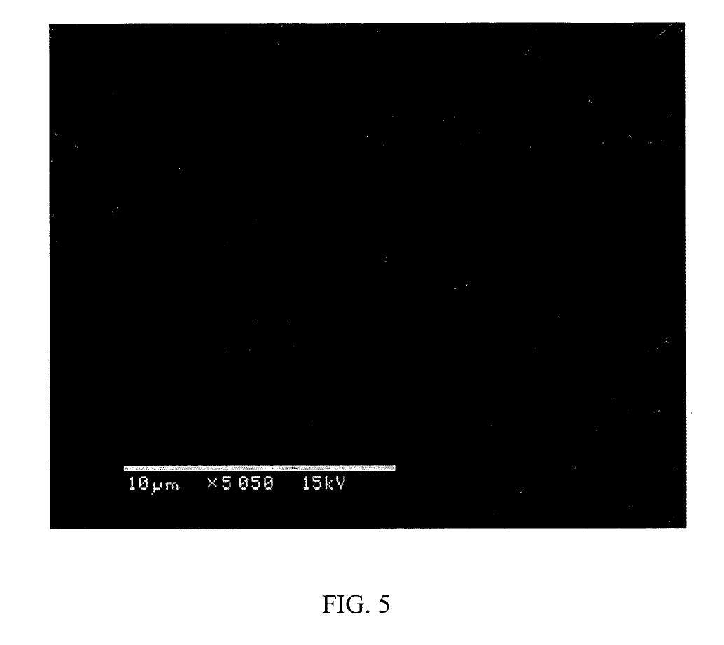

By long lasting durable hydrophilic properties it is meant that composite membrane 20 remains hydrophilic after at least 3 wet then dry cycles with no more than 10 percent of coating washout and permits continued flow through composite membrane 20. For example, a water flow cycle test was conducted that shows that a test composite membrane with a non-crosslinked coating (a fluorinated vinyl based copolymer having sulfonyl functionality) applied and treated as described above has a continued fluid flow after 3 wet dry cycles. FIG. 5 is a scanning electron microscope (SEM) picture of the test composite membrane after the completion of the three cycle test.

Water was first flowed through the test composite membrane 20 at a 13.5 psi pressure drop with a flow rate of 20 ml/min/cm². The test membrane 20 was then allowed to dry at room temperature to complete the first cycle. The second flow cycle resulted in a flow rate of 8.5 ml/min/cm² at a pressure drop of 13.5 psi. The test composite membrane 20 was then allowed to dry at room temperature to complete the second cycle. The third flow cycle resulted in a flow rate of 4.2 ml/min/cm² at a pressure drop of 13.5 psi. The test composite membrane 20 was then allowed to dry at room temperature to complete the third cycle. Known filter membranes typically plug after one wet dry cycle.

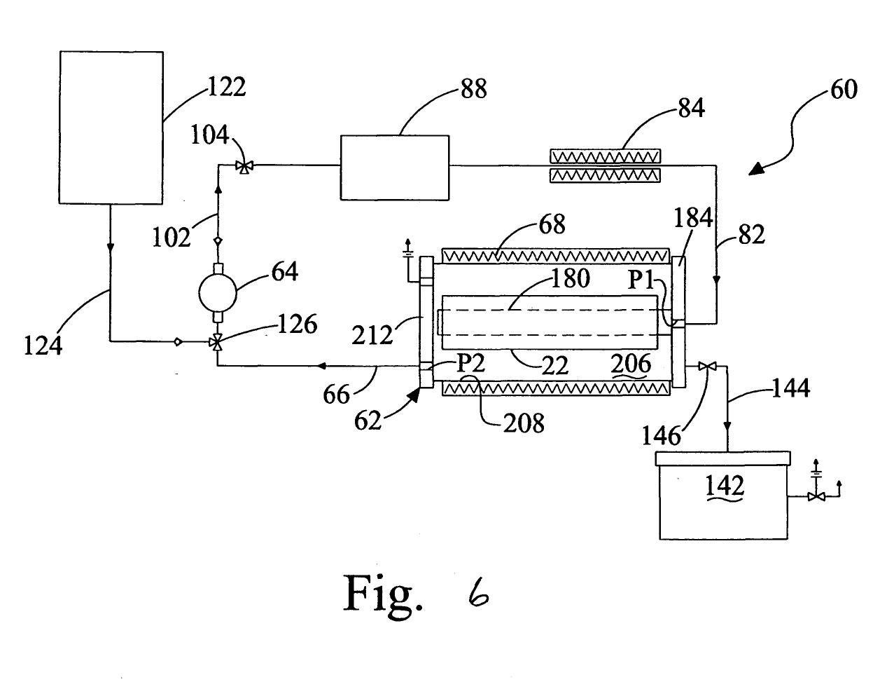

FIG. 6 is a schematic illustration of a supercritical fluid coating apparatus 60 used to apply coating 24 to base membrane 22. In an exemplary embodiment, coating apparatus 60 includes a treatment vessel 62 for applying coating 24 to base membrane 22. Treatment vessel 62 is capable of withstanding pressure up to about 12,320 psi (about 850 bar) and temperature in the range of about 0° C. to about 300° C. (32° F. to 572° F.). Treatment vessel 62 is sized appropriately such that the desired dimensions of base membrane 22 can fit into the treatment vessel housing. Treatment vessel 62 is fluidly connected to a supply and circulation pump 64 by line 66. Treatment vessel 62 has a heater 68 to maintain the walls of treatment vessel 62 at a predetermined temperature. Treatment vessel 62 is located in a fluid circulation loop connected by line 82 to a coating introduction vessel 88. Coating introduction vessel 88 is connected to pump 64 through line 102 and valve 104. Any or all of lines 82, 102 and vessels 62, 88 can be heated or cooled to maintain predetermined process conditions.

Pump 64 is also connected to a solvent storage container 122 through line 124 and valve 126. Storage container 122 houses solvent, for example, carbon dioxide, under pressure and is maintained at a temperature to assure delivery of solvent in a liquid phase to pump 64. In another embodiment, pump 64 is a compressor. Treatment vessel 62 is also connected to separation and recovery station 142 through line 144 and valve 146. Separation and recovery station 142 is vented to atmosphere or may be optionally connected to storage container 122 for recovering CO₂.

Untreated base membrane 22 is processed by first rolling a predetermined amount of base membrane 22 onto a core 180. The ends of the roll of base membrane 22 are secured with known securing mechanisms (not shown) such as clamps to hold base membrane 22. The securing mechanisms (not shown) are sufficiently tightened to prevent axial fluid flow exiting the ends of rolled base membrane 22. Core 180 is made from any suitable material, for example, perforated stainless steel, and includes a multiplicity of radially extending openings.

Core 180 and base membrane 22 are supported in treatment vessel 62 so that membrane 22 does not contact the interior of treatment vessel 62 so fluid can flow around the entire roll of membrane and wet the entire surface area of base membrane 22. Core 180 is attached to a removably securable end cap 184 of treatment vessel 62. Core 180 is shown extending horizontally in FIG. 4. In alternate embodiments (not shown), core 180 and treatment vessel 62 are oriented in a vertical direction or any other orientation. The interior of core 180 is in fluid communication with line 82 through a port P1 in end cap 184.

In operation, a pressure differential in the range of about 1 psi to about 100 psi exists between the inside of core 180 and the outside of the roll of membrane 22. The pressure differential can vary and is a function of fluid flow velocity, roll size, pore size and pore density. Fluid flows from open space 206 in treatment vessel 62 through a port P2 in a second removably securable end cap 212 of treatment vessel 62 into treatment vessel outlet line 66.

To coat base membrane 22, coating material 24 is placed in treatment introduction vessel 88. The amount of coating material 24 depends on the solution concentration desired in the system and the target predetermined add-on weight deposited on membrane 22. Core 180 and roll of membrane 22 are placed in treatment vessel 62 and connected to end cap 184 for fluid flow through the core and membrane. End caps 184 and 212 are secured to seal treatment vessel 62. Membrane 22 is made from a material that does not dissolve in the selected fluid solvent, for example, carbon dioxide.

Valve 146 is closed and valve 126 is positioned to allow fluid flow to the system. Solvent, for example, carbon dioxide, flows from storage container 122 into treatment vessel 62 and the rest of coating system 60 at the storage pressure. Valve 104 is opened. Pump 64 then fills lines 102, 82, 66 and vessel 62 while increasing system pressure. Valve 126 is positioned to block flow from container 122 and permit circulating flow between pump 64 and treatment vessel 62. Pump 64 raises the pressure in the system to a predetermined pressure. Pump 64 continues to cycle solvent, through line 102, through treatment introduction vessel 88, and line 82 and through treatment vessel 62.

The coating material 24 is exposed to the solvent when the solvent flows through treatment introduction vessel 88. Coating material 24 in treatment introduction vessel 88 is entrained or is dissolved in the solvent flowing through it at the predetermined conditions. Any suitable fluid capable of entraining coating material 24 under predetermined conditions can be used and the use of a co-solvent can be employed. In the exemplary embodiment, supercritical carbon dioxide is used. Flow through vessel 88 continues until the desired concentration of coating material 24 solute in the solution is attained. This flow is maintained until a predetermined amount of coating material 24 in treatment introduction vessel 88 is dissolved to obtain a predetermined amount of treatment material entrained in the solvent.

System pressure is controlled to reach a predetermined pressure. The temperature and pressure of the circulating solution is controlled as determined by the solubility of coating material 24 in the solvent so the coating material dissolves for a predetermined solute concentration. Pressure and volume of solvent can be increased in a known manner by a make-up supply and pump (not shown).

Once the predetermined concentration of coating material 24 in the solution is reached and the system pressure and temperature stabilize, the solution is circulated through the system for a predetermined time. By way of example, the solution circulates through pump 64, treatment introduction vessel 88, temperature control device 84, line 82, through end cap 184, into the interior of core 180, through pores 46 in the roll of membrane 22, into space 206 in treatment vessel 62, through cap 212, through line 66 and then back to pump 64. This assures that every pore 46 in the roll of base membrane 22 is exposed to the solution.

When the solution circulates for sufficient time at the predetermined system conditions, pump 64 is stopped. The pressure and/or temperature of the solution are/is then permitted to change to a condition in which coating material 24 is no longer soluble in the supercritical carbon dioxide. Coating material 24 then precipitates out of the solution and is deposited onto membrane 22. The pressure is then further reduced to 1 atmosphere so treatment vessel 62 can be opened. The coating material 24 is deposited onto substantially all the surfaces of nodes 42 and fibrils 44 defining pores 46 in porous base membrane 22.

While the invention has been described in terms of various specific embodiments, those skilled in the art will recognize that the invention can be practiced with modification within the spirit and scope of the claims.

What is claimed is:

1. A composite article comprising:
a porous base membrane comprising a first material having hydrophobic properties; and
a coating layer formed on at least a portion of said porous base membrane, said coating layer comprising a crosslinked coating material, said coating layer provididng hydrophilic properties to the composite article.

2. A composite article in accordance with claim 1 wherein said first material comprises at least one of expanded polytetrafluoroethylene, woven polytetrafluoroethylene, non woven polytetrafluoroethylene, and polyphenelene sulfone.

3. A composite article in accordance with claim 2 wherein said first material comprises expanded polytetrafluoroethylene, and said porous base membrane comprises a plurality of nodes and fibrils defining a plurality of interconnecting pores extending therethrough.

4. A composite article in accordance with claim 1 wherein said coating material comprises fluorinated vinylic-based acrylic-based or fluorinated styrenic-based polymers or copolymers having between about 20 percent to about 70 percent fluorine by weight, and having functional groups comprising at least one of hydroxyl groups, acetate groups, trifluoroacetate groups, acid groups, sulfonyl groups, and sulfonic acid groups.

5. A composite article in accordance with claim 4 wherein said coating material has been chemically treated to convert at least one of sulfonyl groups to sulfonic acid groups and acetate or trifluoroacetate groups to hydroxyl groups.

6. A composite article in accordance with claim 1 wherein said coating layer has a thickness in the range of about 1.0 nanometer to about 500 nanometers.

7. A composite article in accordance with claim 6 wherein said coating layer has a thickness in the range of about 1.0 nanometer to about 100 nanometers.

8. A composite article in accordance with claim 1 wherein said composite article remains hydrophilic after at least 3 wet then dry cycles.

9. A method of making a composite membrane having hydrophilic properties, said method comprising the steps of:
providing a porous membrane comprising a plurality of pores and made from a first material having hydrophobic properties;
dissolving a coating material in a fluid comprising densified gas;
exposing the porous membrane to the coating material dissolved in the densified gas;
depositing a coating of the coating material onto surfaces defining the pores in the porous membrane by changing conditions of the fluid to below a solubility limit of the coating material in the fluid;
crosslinking the coating material to form a coating layer; and
chemically treating the coating material to impart hydrophilic properties to the coating layer, wherein said crosslinking step is performed before or after said chemically treating step.

10. A method in accordance with claim 9 wherein the first material comprises at least one of expanded polytetrafluoroethylene, woven polytetrafluoroethylene, and polyphenelene sulfone.

11. A method in accordance with claim 10 wherein the first material comprises expanded polytetrafluoroethylene said forming a porous membrane comprises extruding polytetrafluoroethylene and stretching the extruded polytetrafluoroethylene to form a plurality of nodes and fibrils defining a plurality of interconnecting pores extending therethrough.

12. A method in accordance with claim 9 wherein the coating material comprises fluorinated vinylic-based, acrylic-based or fluorinated styrenic-based polymers or copolymers having between about 20 percent to about 70 percent fluorine by weight, and having functional groups comprising at least one of hydroxyl groups, acetate groups, trifluoroacetate groups, acid groups, sulfonyl groups, and sulfonic acid groups.

13. A method in accordance with claim 12 wherein chemically treating the coating material comprises treating the coated surfaces of the porous membrane to convert at least one of sulfonyl groups to sulfonic acid groups and acetate or trifluoroacetate groups to hydroxyl groups.

14. A method in accordance with claim 9 wherein the coating layer has a thickness in the range of about 1.0 nanometer to about 500 nanometers.

15. A method in accordance with claim 9 wherein chemically treating the coating material to impart hydrophilic properties to the coating layer comprises chemically treating the coating material to impart hydrophilic properties to the coating layer wherein the coating layer remains hydrophilic after at least 3 wet then dry cycles.

16. A composite membrane comprising:
a porous base membrane comprising a first material having hydrophobic properties; and
a coating layer formed on at least a portion of said porous membrane, said coating layer comprising a coating material;
said coating material comprising at least one of fluorinated vinyl-based copolymers having sulfonyl functionality, fluorinated acrylic-based copolymers having at least one of hydroxyl groups, acid groups, sulfonyl groups, and sulfonic acid groups, and fluorinated styrenic-based copolymers having at least one of hydroxyl groups, acetate groups, trifluoroacetate groups, acid groups, sulfonyl groups, and sulfonic acid groups.

17. A composite membrane in accordance with claim 16 wherein said coating material has been chemically treated to convert at least one of sulfonyl groups to sulfonic acid groups and acetate or trifluoroacetate groups to hydroxyl groups to impart hydrophilic properties to the coating layer.

18. A composite membrane in accordance with claim 17 wherein said coating material is crosslinked.

19. A composite membrane in accordance with claim 16 wherein said first material comprises at least one of expanded polytetrafluoroethylene, woven polytetrafluoroethylene, non woven polytetrafluoroethylene, and polyphenelene sulfone.

20. A composite membrane in accordance with claim 16 wherein said coating layer has a thickness in the range of about 1.0 nanometer to about 500 nanometers.
